(19) United States
(12) Patent Application Publication
(10) Pub. No.: US 2011/0272957 A1
(43) Pub. Date: Nov. 10, 2011

(54) Vehicle grasping apparatus

(76) Inventor: Rene H. Fetch, Mandan, ND (US)

(21) Appl. No.: 12/800,131

(22) Filed: May 10, 2010

(51) Int. Cl. B60R 99/00

(52) U.S. Cl. 294/106

(57) ABSTRACT

A vehicle-to-vehicle grasping apparatus which utilizes a pair of top and bottom clamp fingers to grasp the back end of a fleeing vehicle. The clamp fingers are opened and closed through the use of a pneumatic cylinder and rod. The grasping apparatus is connected to the front bumper of a motor vehicle. When not in use, the clamp fingers of the grasping apparatus are maintained in a closed position. When a fleeing vehicle is to be stopped, the chase vehicle operator would cause the pneumatic cylinder of the grasping apparatus to be pressurized so that the clamp fingers are in an open position. Once the impact or proximity triggers of the grasping apparatus come into contact with the fleeing vehicle, the clamp fingers instantly close upon the fleeing vehicle's rear bumper or trunk. By applying the chase vehicle's brakes, the fleeing vehicle will be sufficiently slowed or stopped.

### BACKGROUND OF THE INVENTION

1. Field of the Invention

The present invention relates generally to vehicle stopping apparatuses, and more specifically to devices for remotely preventing car movement.

2. Description of Related Art

Vehicular police pursuits of criminal suspects happen on a daily basis and can, needless to say, result in harm to innocent bystanders, especially in densely populated urban areas. For this reason and for the sake of apprehending a fleeing criminal, it is highly desirable to stop such pursuits before unnecessary harm can result. Because a police car pursuing a criminal suspect's vehicle is typically directly behind the chased vehicle, an effective device for stopping the suspect's vehicle must operate remotely from that vehicle.

What is needed is a device that will accurately and effectively disable a fleeing vehicle. The device should be usable regardless of the path that the fleeing vehicle takes. Numerous efforts have been made in these regards, yet nothing prior to the present invention meets the clear need for a device for disabling a fleeing vehicle.

U.S. Pat. No. 2,353,386, issued on Jul. 11, 1944, to Charles D. Bourcier, describes a device for deflating pneumatic tires. The device acts by passively providing a conduit between the inside space of such a tire and the environment. U.S. Pat. No. 4,055,104, issued on Oct. 25, 1977, to Irving B. Osofsky et al., describes a tire-piercing device which is intended to be imbedded in a paved surface. U.S. Pat. No. 4,382,714, issued on May 10, 1983, to Walter G. Hutchison, describes a passive device for deflating pneumatic tires by providing a conduit between the inside space of such a tire and the environment. The device may be interconnected with similar devices, which are together placed on pavement where a vehicle is expected to pass. U.S. Pat. No. 4,995,756, issued on Feb. 26, 1991, to Donald C. Kilgrow et al., describes a tire deflator with a supporting base that supports and then releases puncturing conduits once such conduits are imbedded in tires. U.S. Pat. No. 5,243,894, issued on Sep. 14, 1993, to Michael A. Minovitch, describes a blinding light intended to immobilize assailants. The light is not used to guide or aim a projectile. U.S. Pat. No. 5,253,950, issued on Oct. 19, 1993; to Donald C. Kilgrow et al., describes a foldable tire deflator. There is no projectile and no laser aiming or guiding. U.S. Pat. No. 5,328,292; issued on Jul. 12, 1994, to Francis R. Williams, describes a tire-puncturing traffic barrier chain. U.S. Pat. No. 5,330,285, issued on Jul. 19, 1994, to Kenneth J. Greves et al., describes an apparatus for deflating tires that is collapsible. It is to be placed in front of cars.

All of the above patents are drawn to devices useful for deflating tires of a vehicle. Upon deflation of the tires, the driver no longer retains control of the vehicle, thereby possibly subjecting both law enforcement officers and bystanders to serious injury from the uncontrollable vehicle. Moreover, the rate of success for a tire deflation apparatus is relatively low. Furthermore, the law enforcement officer typically possesses one such tire deflation apparatus. Thus, if the law enforcement officer is not given a second chance if not successful on the first attempt.

Accordingly, it is the primary object of the present invention to provide an apparatus which allows law enforcement officers to safely slow down a pursued vehicle and to bring the pursued vehicle to a stop without endangering citizens or their property. Furthermore, with the present invention, if a law enforcement officer is not successful in disabling the pursued vehicle on his first attempt, he can continue to utilize the apparatus until the pursued vehicle has been safely stopped.

### SUMMARY OF THE INVENTION

By the present invention, an improved vehicle grasping apparatus is disclosed for quickly and safely grasping irregularly shaped objects, such as a bumper. The invention discloses an improved pair of spaced, opposed gripping fingers which gripping fingers can be drawn together to grasp and hold an object or objects within the fingers. Likewise, the fingers can be pivoted to open the grasping region to release an object from the grip of the grasping apparatus. The grasping apparatus is fixedly attached to the front frame of a motor vehicle.

It is, therefore, an object of the present invention to provide a grasping apparatus for use in seizing one vehicle from a following or trailing vehicle.

It is another object of the present invention to provide a grasping apparatus which can be adapted to positively grip an object of irregular size or shape without causing a misgrip.

It is another object of the invention to provide a means for disabling a pursued vehicle while maintaining control of the pursued vehicle.

It is another object of the invention to provide a grasping apparatus which can be easily installed on existing law enforcement vehicles.

Still another object of the invention is to prevent harm to innocent bystanders as a result of a police pursuit.

Still another object of the invention is to enable the fingers to close automatically upon the grasping apparatus coming into contact with the pursued motor vehicle.

It is an object of the invention to provide improved elements and arrangements thereof in an apparatus for the purposes described which is inexpensive, dependable and fully effective in accomplishing its intended purposes.

These, and other, aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made without the scope of the present invention without departing from the spirit thereof, and the invention includes all such modifications.

### BRIEF DESCRIPTION OF THE DRAWINGS

FIG. 1 is a side perspective view of the vehicle-to-vehicle grasping apparatus with the clamp fingers in the closed or grasping position.

FIG. 2 is a side perspective view of the vehicle-to-vehicle grasping apparatus with the clamp fingers in the open position.

FIG. 3 is a perspective view of the vehicle-to-vehicle grasping apparatus with a side plate removed and the pneumatic cylinder and cylinder rod visible.

FIG. 4 is a perspective view of the vehicle-to-vehicle grasping apparatus with a side plate removed and the mechanical link visible.

FIG. 5 is a rear perspective view of the vehicle-to-vehicle grasping apparatus with the clamp fingers in the closed or grasping position.

FIG. 6 is a rear perspective view of the vehicle-to-vehicle grasping apparatus with the clamp fingers in the open position.

FIG. 7 is a perspective view of the vehicle-to-vehicle grasping apparatus.

FIG. 8 is a perspective view of the vehicle-to-vehicle grasping apparatus, front bumper and covering.

FIG. 9 is a side perspective view of the vehicle-to-vehicle grasping apparatus.

FIG. 10 is a side perspective view of a top clamp finger of the vehicle-to-vehicle grasping apparatus.

FIG. 11 is a side perspective view of a bottom clamp finger of the vehicle-to-vehicle grasping apparatus.

FIG. 12 is a top perspective view of the mechanical link of the vehicle-to-vehicle grasping apparatus.

FIG. 13 is a perspective view of the alternative embodiment of the vehicle-to-vehicle grasping apparatus.

FIG. 14 is a side perspective view of a top clamp finger of the alternative embodiment of the vehicle-to-vehicle grasping apparatus.

FIG. 15 is a side perspective view of a bottom clamp finger of the alternative embodiment of the vehicle-to-vehicle grasping apparatus.

FIG. 16 is a perspective view of the alternative embodiment of the vehicle-to-vehicle grasping apparatus with a side plate removed and the pneumatic cylinder and cylinder rod visible.

FIG. 17 are perspective views of the alternative embodiment of the vehicle-to-vehicle grasping apparatus with a side plate removed.

### DESCRIPTION OF THE PREFERRED EMBODIMENTS

When automobile police pursuits occur, there is a risk of harm to innocent bystanders stemming from reckless driving. Moreover, the pursued automobile in such a pursuit must be stopped to apprehend the fleeing driver. For these reasons, it is highly desirable to provide a device that law enforcement officials can use to stop a chased automobile, while it is being chased. Because a path of a chased vehicle cannot generally be predicted, a mere stationary blockade cannot provide the desired effect of stopping a chased automobile. Instead, the present invention provides a device which law enforcement can utilize to slow down or stop a chased vehicle at a location deemed appropriate by the law enforcement officer.

The present invention and the various features and advantageous details thereof are explained more fully with reference to the non-limiting embodiments described in the following description.

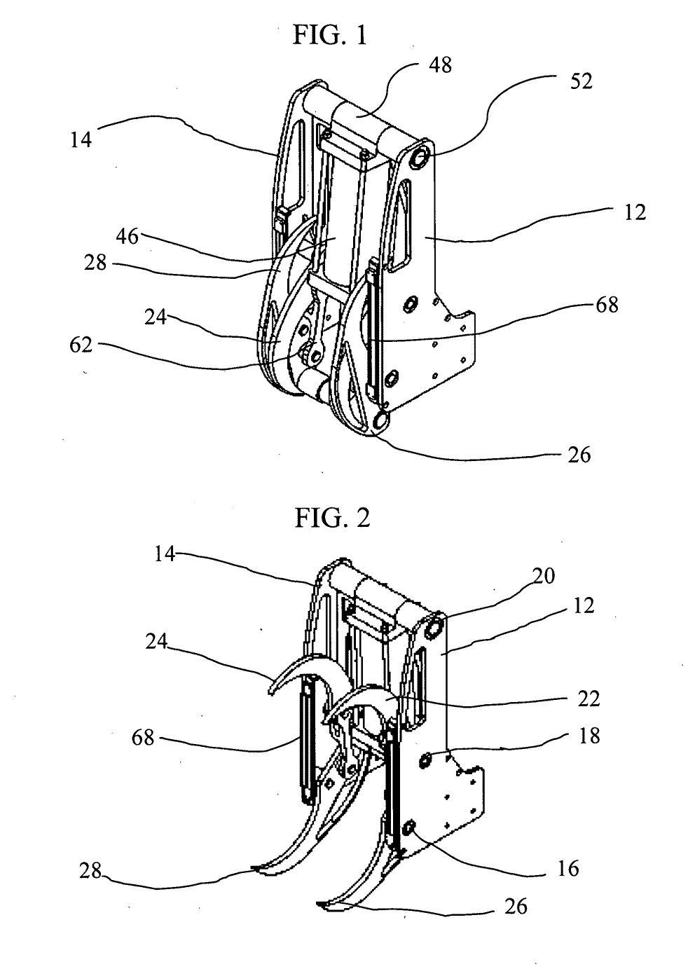

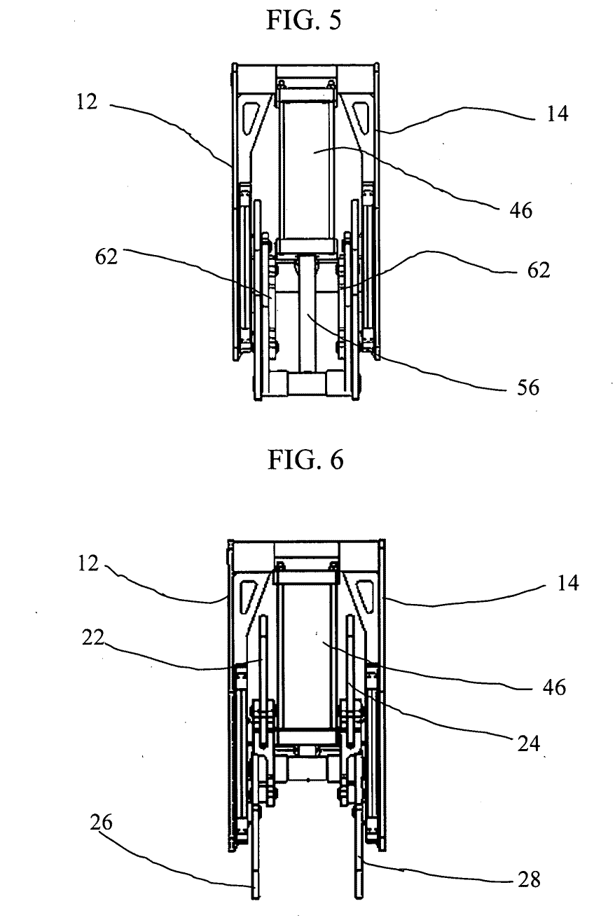

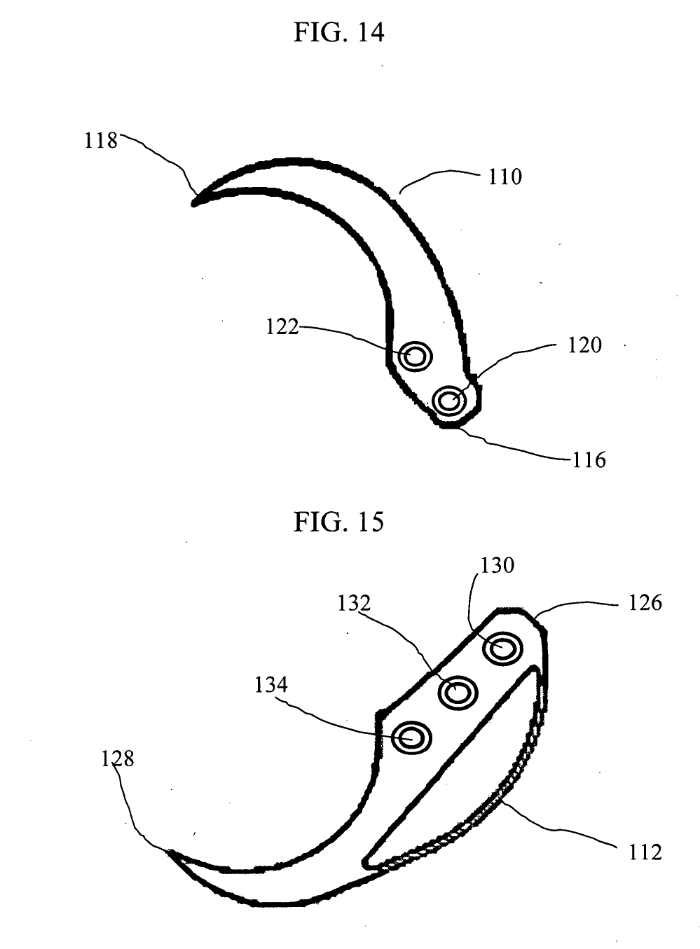

Reference is now made to FIGS. 1 to 17, the grasping apparatus is comprised of a first side plate 12, and a second side plate 14 which side plates 12, 14 are generally “L” shaped. Adjacent to the distal ends of the side plates 12, 14 are first circular openings 16. At the midpoint of the side plates 12, 14 are second circular openings 18. At the proximal ends of the side plates 12, 14 are third circular openings 20.

Referring to FIGS. 1, 2, 3 and 4, in the preferred embodiment of the present invention, the gripping device consists of a first top clamp finger 22, a second top clamp finger 24, a first bottom clamp finger 26 and a second bottom clamp finger 28.

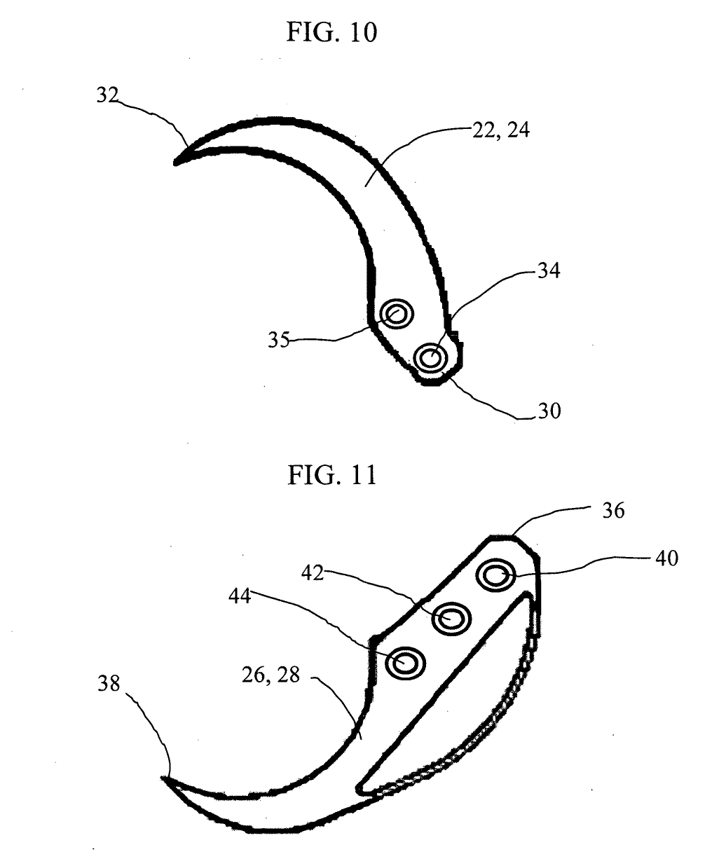

Referring to FIG. 10, the top clamp fingers 22, 24 are generally arcuate members that extend from a first end 30 to a second end 32 defining the tip of the top clamp fingers 22, 24. Adjacent to the first end 30 of the top clamp fingers 22, 24 is a first circular opening 34. Contiguous to the first circular opening 34 is a second circular opening 35. Referring to FIG. 11, the bottom clamp fingers 26, 28 are likewise generally arcuate with a rectangular-shaped extension having a first end 36 and a second end 38 with the second end 38 defining the tip of the bottom clamp fingers 26, 28. Three circular openings are maintained on the rectangular portion of the bottom clamp fingers 26, 28 with the first circular opening 40 being adjacent to the first end 36. The second circular opening 42 and the third circular opening 44 are in spaced relation to the first circular opening 40.

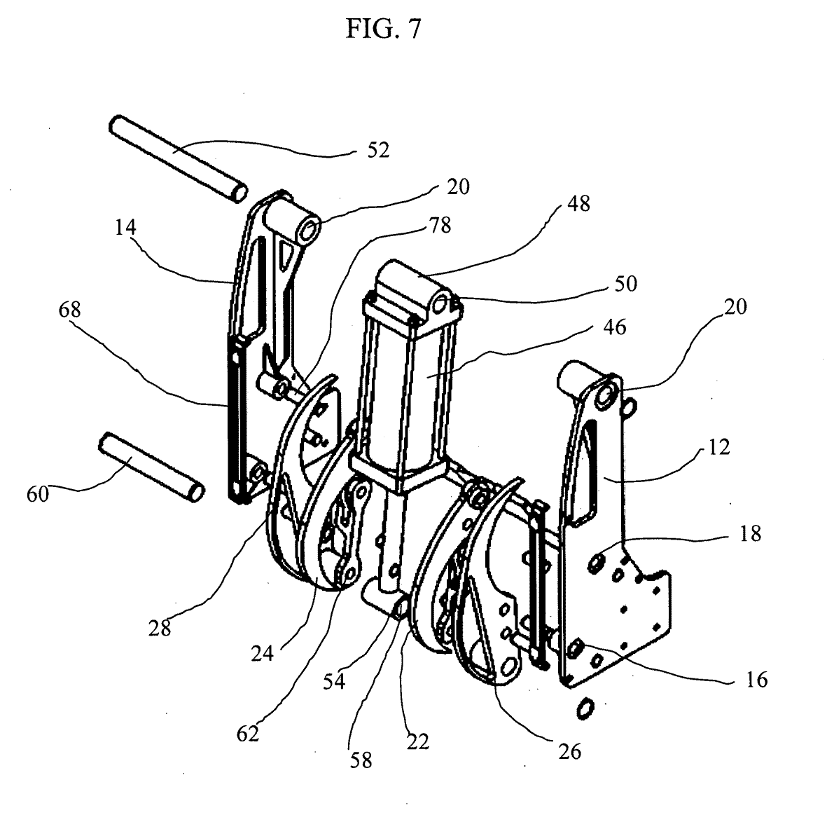

Referring to FIGS. 4 and 7, the top clamp fingers 22, 24 are rotatably attached to the side plates 12, 14 by means of a pivot pin 78. To rotatably attach the top clamp fingers 22, 24 to the side plates 12, 14, the first circular opening 34 of a top clamp finger 22, 24 is aligned with the second circular side plate opening 18. A pivot pin 78 is inserted into the opening, thereby enabling the top clamp fingers 22, 24 to rotate about the side plates 12, 14.

The grasping apparatus further includes a pneumatic cylinder 46 maintained within the first and second side plates 12, 14. The first end 48 of the pneumatic cylinder 46, having a horizontally extending cylindrical opening 50, is removably maintained between the first and second side plates 12, 14 by means of a pivot pin 52. The pivot pin 52 is retained within the third circular openings 20 of the first and second side plates 12, 14 and the horizontally extending opening 50.

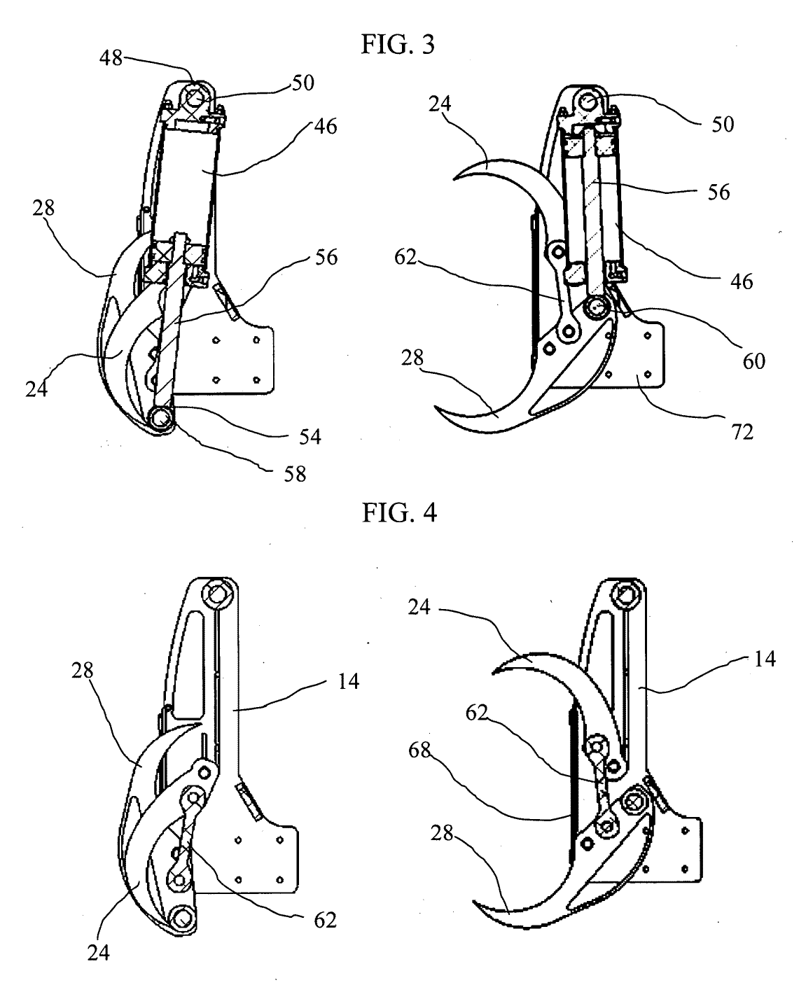

Referring to FIG. 3, the second end 54 of the pneumatic cylinder 46 is found at the distal end of the cylinder rod 56 with said second end 54 having a cylindrical opening 58. The second end 54 is removably attached to the bottom clamp fingers 26, 28 by means of a pivot pin 60. The cylindrical opening 58 of the cylinder rod 56 is aligned with the first circular opening 40 of the bottom clamp fingers 26, 28. The pivot pin 60 is inserted into the aligned openings so as to allow the bottom clamp fingers 26, 28 to rotate about the pivot pin 60. Referring to FIGS. 3 and 4, when the cylinder rod 56 is in its extended position; the bottom clamp fingers 26, 28 are rotated to a closed position. Conversely, when the cylinder rod 56 is in a retracted position, the bottom clamp fingers 26, 28 are rotated to an open position.

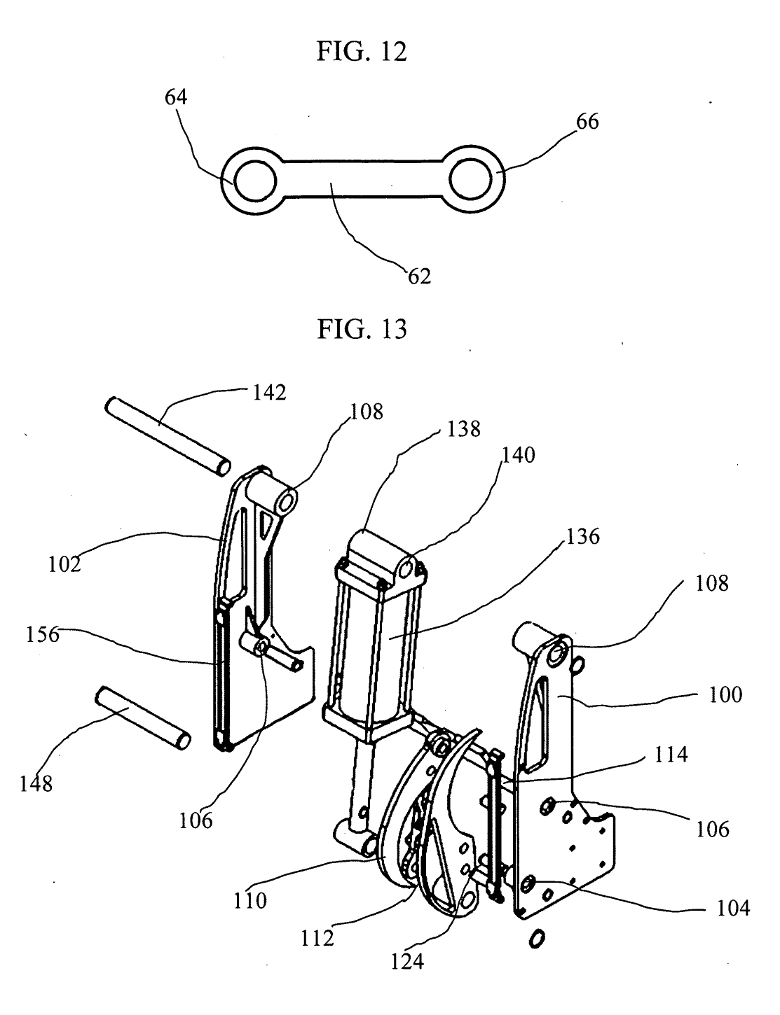

To synchronize the rotation of the top clamp fingers 22, 24 with the bottom clamp fingers 26, 28, the bottom clamp fingers 26, 28 are removably attached to the top claim fingers 22, 24 by a pair of mechanical links 62. Referring to FIG. 12, the mechanical links 62 have a first end 64 and a second end 66 with circular openings adjacent to each end.

As illustrated in FIG. 7, the opening adjacent to the first end 64 of the mechanical link 62 is aligned with and rotatably attached with a pivot pin to the second circular opening 35 of the top clamp fingers 22, 24. The opening adjacent to the second end 66 of the mechanical link 62 is aligned with and rotatably attached with a pivot pin to the second circular opening 42 of the bottom clamp fingers 26, 28.

The gripping device further contains an impact or proximity trigger 68 which causes the clamp fingers 22, 24, 26 and 28 to close immediately upon contact with the forward vehicle.

In an alternative embodiment of the present invention, the grasping apparatus utilizes a single set of clamp fingers. Reference is now made to FIG. 13, the alternative embodiment of the grasping apparatus is comprised of a first side plate 100, and a second side plate 102 which side plates 100, 102 are generally “L” shaped. Adjacent to the distal end of the first side plate 100 is first circular opening 104. At the midpoint of the side plates 100, 102 are second circular openings 106. At the proximal ends of the side plates 100, 102 are third circular openings 108.

In the alternative embodiment of the present invention, the gripping device consists of a top clamp finger 110 and a bottom clamp finger 112. The top clamp finger 110 is rotatably attached to the first side plate 100 by means of a pivot pin 114. To rotatably attach the top clamp finger 110 to the first side plate 100, the first circular opening 120 of the top clamp finger 110 is aligned with the second circular side plate opening 106. A pivot pin 114 is inserted into the openings 106, 120, thereby enabling the top clamp finger 110 to rotate about the side plates 100, 102. The bottom clamp finger 112 is similarly rotatably attached to the first side plate 100 by means of a pivot pin 124. The third circular opening 134 of the bottom clamp finger 112 is aligned with the first circular side plate opening 104. A pivot pin 124 is inserted into the openings 104, 134, thereby enabling the bottom clamp finger 112 to rotate about the first side plate 100.

The alternative embodiment of the present invention further includes a pneumatic cylinder 136 maintained between the first and second side plates 100, 102. The first end 138 of the pneumatic cylinder 136, having a horizontally extending cylindrical opening 140, is removably maintained between the first and second side plates 100, 102 by means of a pivot pin 142. The pivot pin 142 is retained within the third circular openings 108 of the first and second side plates 100, 102 and the horizontally extending opening 140.

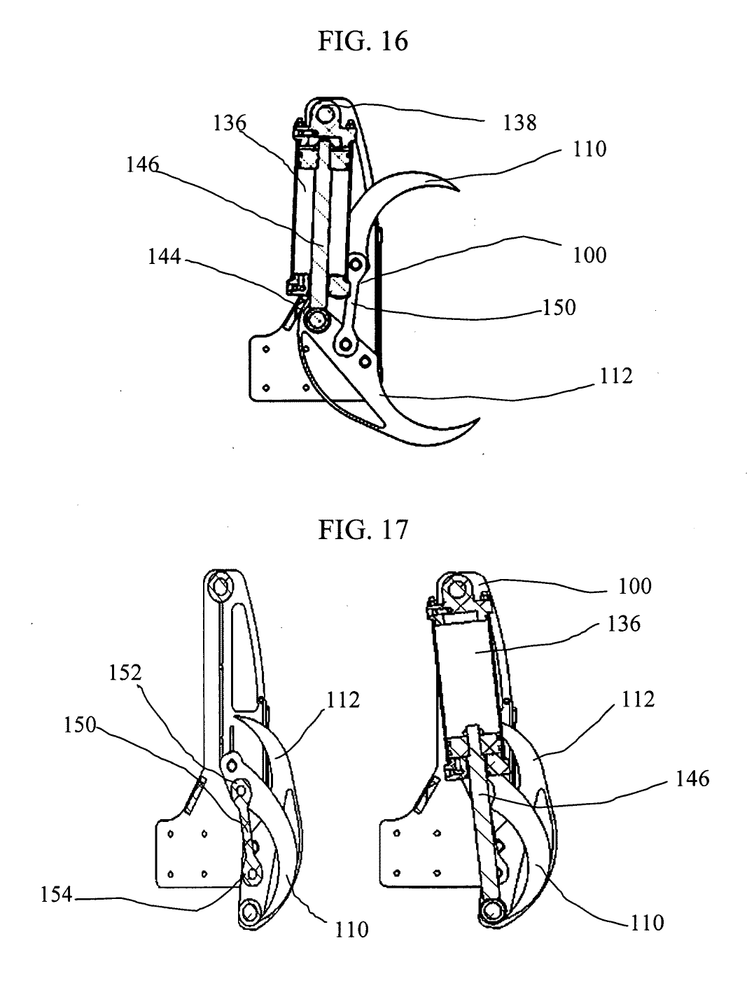

Referring to FIGS. 16 and 17, the second end 144 of the pneumatic cylinder 136 is found at the distal end of the cylinder rod 146 with said second end 144 having a cylindrical opening. The second end 144 is removably attached to the bottom clamp finger 112 by means of a pivot pin 148. The cylindrical opening of the cylinder rod 146 is aligned with the first circular opening 130 of the bottom clamp finger 112. The pivot pin 148 is inserted into the aligned openings 130, 144 so as to allow the bottom clamp finger 112 to rotate about the pivot pin 148. Referring to FIGS. 16 and 17, when the cylinder rod 146 is in its extended position, the bottom clamp finger 112 is rotated to a closed position. Conversely, when the cylinder rod 146 is in a retracted position, the bottom clamp finger 112 is rotated to an open position.

To synchronize the rotation of the top clamp finger 110 with the bottom clamp finger 112, the bottom clamp finger 112 is removably attached to the top claim finger 110 by a mechanical link 150. Referring to FIG. 17, the mechanical link 150 has a first end 152 and a second end 154 with circular openings adjacent to each end 152, 154.

As illustrated in FIG. 17, the opening adjacent to the first end 152 of the mechanical link 150 is aligned with and rotatably attached with a pivot pin to the second circular opening 122 of the top claim finger 110. The opening adjacent to the second end 154 of the mechanical link 150 is aligned with and rotatably attached with a pivot pin to the second circular opening 132 of the bottom clamp finger 112.

The alternative embodiment of the present invention further contains an impact or proximity trigger 156 which causes the clamp fingers 100, 102 to close immediately upon contact with the forward vehicle.

To engage the clamp fingers 22, 24, 26, 28, 110, 112 to enable the gripping device to attach to another vehicle, the law enforcement officer simply retracts the cylinder rod 56, 146 of the pneumatic cylinder 46, 136 through a remote control device (not shown). The retraction of the cylinder rod 56, 146 causes the bottom clamp fingers 26, 28, 112 to rotate in a downward direction. Referring to FIGS. 2, 3, 4 and 17 as the bottom clamp fingers 26, 28, 112 rotate, the mechanical links 62, 150 cause the top clamp fingers 22, 24, 110 to rotate in an upward position, thereby resulting in the clamp fingers 22, 24, 26, 28, 110, 112 being in an open position.

Upon the forward vehicle coming into contact with the impact or proximity triggers 68, 156 the cylinder rod 56, 146 is instantly extended. The extended cylinder rod 56, 146 pushes the first end 36, 130 of the bottom clamp fingers 26, 28, 112 in a downward direction causing the second end 38, 128 of the bottom clamp fingers 26, 28, 112 to travel in an upward direction with the second end 38, 128 coming into contact with the bottom side of the forward vehicle. As the bottom clamp fingers 26, 28, 112 rotate, the mechanical links 62, 150 cause the simultaneous rotation of the top clamp fingers 22, 24, 110 resulting in the second end 32, 118 of the first clamp fingers 22, 24, 110 rotating in a downward direction and coming into contact with the back end of the forward vehicle.

Once the clamp fingers 22, 24, 26, 28, 110, 112 are in the closed position, the law enforcement officer need simply apply the brakes of his or her vehicle to slow or stop the forward vehicle. To open the clamp fingers 22, 24, 26, 28, 110, 112 when in the closed position, the law enforcement officer simply retracts the cylinder rod 56, 146 of the pneumatic cylinder 46, 136 through a remote control device (not shown).

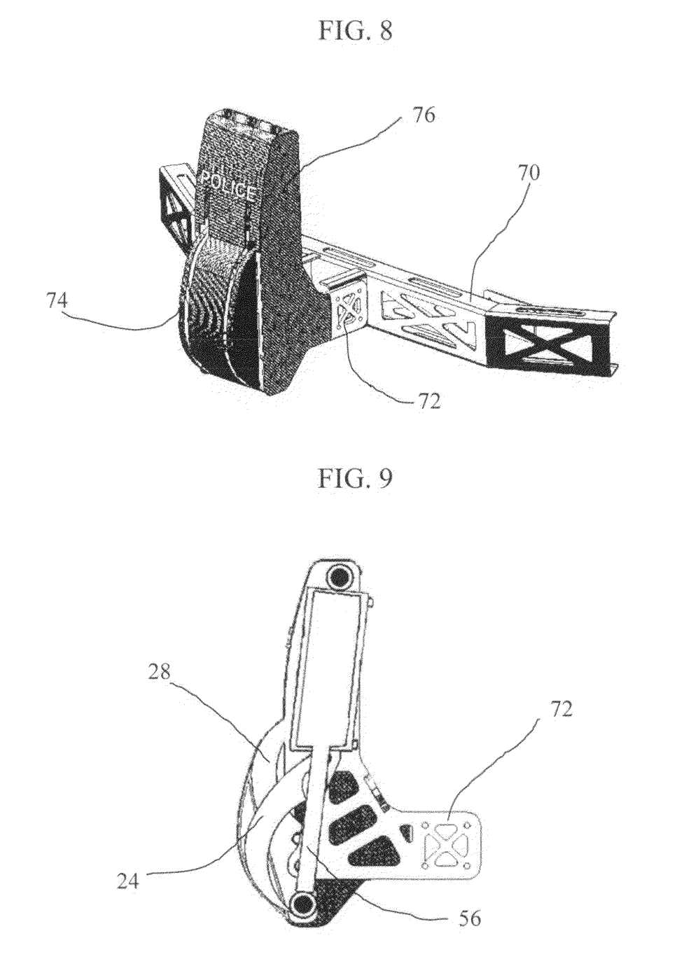

In the preferred and alternative embodiments, the grasping apparatus is attached to the front bumper 70 of a motor vehicle (see FIG. 8) by means of the bumper flange 72 of the first and second side plates 12, 14. To disguise the grasping apparatus when not in use, a front cover 74 and side covers 76 can be applied without limiting or otherwise restricting the functionality of the grasping apparatus.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept.

The individual components mentioned herein need not be fabricated from the disclosed materials, but could be fabricated from virtually any suitable and strong materials.

Moreover, the individual components need not be formed in the disclosed shapes, or assembled in the disclosed configuration, but could be provided in virtually any shape, and assembled in virtually any suitable configuration. It is intended that the appended claims cover all such additions, modifications and rearrangements.

Index of Elements for Vehicle Grasping Apparatus

| | |
|---|---|
| 12. | First Side Plate |
| 14. | Second Side Plate |
| 16. | Side Plate First Circular Opening |
| 18. | Side Plate Second Circular Opening |
| 20. | Side Plate Third Circular Opening |
| 22. | First Top Clamp Finger |
| 24. | Second Top Clamp Finger |
| 26. | First Bottom Clamp Finger |
| 28. | Second Bottom Clamp Finger |
| 30. | Top Finger First End |
| 32. | Top Finger Second End |
| 34. | Top Finger First Opening |
| 35. | Top Finger Second Opening |
| 36. | Bottom Finger First End |
| 38. | Bottom Finger Second End |
| 40. | Bottom Finger First Opening |
| 42. | Bottom Finger Second Opening |
| 44. | Bottom Finger Third Opening |
| 46. | Pneumatic Cylinder |
| 48. | Cylinder First End |
| 50. | Horizontally Extending Opening |
| 52. | Pivot Pin |
| 54. | Cylinder Second End |
| 56. | Cylinder Rod |
| 58. | Cylinder Cylindrical Opening |
| 60. | Pivot Pin |
| 62. | Mechanical Link |
| 64. | Link First End |
| 66. | Link Second End |
| 68. | Impact or Proximity Trigger |
| 70. | Front Bumper |
| 72. | Bumper Flange |
| 74. | Cover |
| 76. | Cover |
| 78. | Pivot Pin |
| 80. | |
| 82. | |
| 84. | |
| 86. | |
| 88. | |
| 90. | |
| 92. | |
| 94. | |
| 96. | |
| 98. | |
| 100. | First Side Plate |
| 102. | Second Side Plate |
| 104. | Plate First Opening |
| 106. | Plate Second Opening |
| 108. | Plate Third Opening |
| 110. | Top Clamp Finger |
| 112. | Bottom Clamp Finger |
| 114. | Pivot Pin |
| 116. | Top Finger First End |
| 118. | Top Finger Second End |
| 120. | Top Finger First Opening |
| 122. | Top Finger Second Opening |
| 124. | Pivot Pin |
| 126. | Bottom Finger First End |
| 128. | Bottom Finger Second End |
| 130. | Bottom Finger First Opening |
| 132. | Bottom Finger Second Opening |
| 134. | Bottom Finger Third Opening |
| 136. | Pneumatic Cylinder |
| 138. | Cylinder First End |
| 140. | Horizontally Extending Opening |
| 142. | Pivot Pin |
| 144. | Cylinder Second End |
| 146. | Cylinder Rod |
| 148. | Pivot Pin |
| 150. | Mechanical Link |
| 152. | Link First End |
| 154. | Link Second End |
| 156. | Impact or Proximity Trigger |

What is claimed is:

1. A vehicle grasping apparatus removably attached to the front end of a motor vehicle comprising:
a first “L” shaped side plate having circular openings at the distal end, midpoint and proximal end of said first side plate;
a second “L” shaped side plate having circular openings at the distal end, midpoint and proximal end of said second side plate;
a arcuate first top clamp finger extending from a first end to a second end defining the tip of the first top clamp finger with a first circular opening adjacent to the first end and contiguous to the first circular opening is a second circular opening;
a arcuate second top clamp finger extending from a first end to a second end defining the tip of the second top clamp finger with a first circular opening adjacent to the first end and contiguous to the first circular opening is a second circular opening;
a arcuate first bottom clamp finger with a rectangular-shaped extension having a first end containing three circular openings and a second end defining the tip of the first bottom clamp finger;
a arcuate second bottom clamp finger with a rectangular-shaped extension having a first end containing three circular openings and a second end defining the tip of the second bottom clamp finger;
a pneumatic cylinder having a cylinder rod with the first end of the pneumatic cylinder, having a horizontally extending cylindrical opening, removably maintained between the first and second side plates and the second end of the pneumatic cylinder is at the distal end of the cylinder rod with said second end having a cylindrical opening;
a pair of mechanical links with each said mechanical link having a first end and a second end with circular openings adjacent to each end;
a plurality of pivot pins; and
one or more impact or proximity triggers.

2. The apparatus of claim 1 wherein the first and second top clamp fingers are rotatably attached to the first and second side plates by means of pivot pins.

3. The apparatus of claim 1 wherein the top clamp fingers are rotatably attached to the side plates by aligning the first circular opening of the top clamp finger with the second circular side plate opening and inserting a pivot pin into the aligned openings.

4. The apparatus of claim 1 wherein the first end of the pneumatic cylinder is removably maintained between the first and second side plates by means of a pivot pin and the second end of the pneumatic cylinder is removably attached to the bottom clamp fingers by means of a pivot pin.

5. The apparatus of claim 1 wherein the opening adjacent to the first end of each mechanical link is aligned with and rotatably attached with a pivot pin to the second circular opening of each top clamp finger and the opening adjacent to the second end of each mechanical link is aligned with and rotatably attached with a pivot pin to the second circular opening of each bottom clamp finger.

6. The apparatus of claim 1 wherein the pneumatic cylinder is utilized to move the clamp fingers to an open position and a closed position.

7. The apparatus of claim 1 wherein the clamp fingers are engaged to enable the gripping apparatus to attach to another vehicle by retracting the cylinder rod of the pneumatic cylinder through a remote control device which causes the bottom clamp fingers to rotate in a downward direction, as the bottom clamp fingers rotate, the mechanical links cause the top clamp fingers to rotate in an upward position, thereby resulting in the clamp fingers being in an open position and upon the forward vehicle coming into contact with the impact or proximity triggers the cylinder rod is extended pushing the first end of the bottom clamp fingers in a downward direction causing the second end of the bottom clamp fingers to travel in an upward direction and come into contact with the bottom side of the forward vehicle, as the bottom clamp fingers rotate, the mechanical links cause the simultaneous rotation of the top clamp fingers resulting in the second end of the top clamp fingers rotating in a downward direction and coming into contact with the back end of the forward vehicle.

8. A vehicle grasping apparatus removably attached to the front end of a motor vehicle comprising:
a first “L” shaped side plate;
a second “L” shaped side plate;
a first top clamp finger;
a second top clamp finger;
a first bottom clamp finger;
a second bottom clamp finger;
a pneumatic cylinder;
a pair of mechanical links;
a plurality of pivot pins; and
one or more impact or proximity triggers.

9. The apparatus of claim 8 wherein the first and second side plates have circular openings at the distal end, midpoint and proximal end.

10. The apparatus of claim 8 wherein the top clamp fingers are generally arcuate members that extend from a first end to a second end defining the tip of the top clamp fingers, adjacent to the first end of the top clamp fingers is a first circular opening and contiguous to the first circular opening is a second circular opening.

11. The apparatus of claim 8 wherein the bottom clamp fingers are generally arcuate with a rectangular-shaped extension having a first end and a second end with the second end defining the tip of the bottom clamp fingers; three circular openings are maintained on the rectangular portion of the bottom clamp fingers with the first circular opening being adjacent to the first end, the second circular opening and the third circular opening are in spaced relation to the first circular opening.

12. The apparatus of claim 8 wherein the top clamp fingers are rotatably attached to the side plates by means of pivot pins.

13. The apparatus of claim 8 wherein the pneumatic cylinder is maintained within the first and second side plates with the first end of the pneumatic cylinder, having a horizontally extending cylindrical opening, removably maintained between the first and second side plates by means of a pivot pin and the second end, having a cylindrical opening, is removably attached to the bottom clamp fingers by means of a pivot pin.

14. The apparatus of claim 8 wherein the mechanical links have a first end and a second end with circular openings adjacent to each end which opening adjacent to the first end is aligned with and rotatably attached with a pivot pin to the top clamp fingers and which opening adjacent to the second end is aligned with and rotatably attached with a pivot pin to the bottom clamp fingers.

15. The apparatus of claim 8 wherein the clamp fingers are engaged to enable the gripping apparatus to attach to another vehicle by retracting the cylinder rod of the pneumatic cylinder causing the bottom clamp fingers to rotate in a downward direction, as the bottom clamp fingers rotate, the mechanical links cause the top clamp fingers to rotate in an upward position, thereby resulting in the clamp fingers being in an open position and upon the forward vehicle coming into contact with the impact or proximity triggers the cylinder rod is extended pushing the first end of the bottom clamp fingers in a downward direction causing the second end of the bottom clamp fingers to travel in an upward direction and come into contact with the bottom side of the forward vehicle, as the bottom clamp fingers rotate, the mechanical links cause the simultaneous rotation of the top clamp fingers resulting in the second end of the top clamp fingers rotating in a downward direction and coming into contact with the back end of the forward vehicle.

16. A vehicle grasping apparatus removably attached to the front end of a motor vehicle comprising:
a first “L” shaped side plate having circular openings at the distal end, midpoint and proximal end of said first side plate;
a second “L” shaped side plate having circular openings at the distal end, midpoint and proximal end of said second side plate;
a top clamp finger extending from a first end to a second end defining the tip of the first top clamp finger with a first circular opening adjacent to the first end and contiguous to the first circular opening is a second circular opening;
a bottom clamp finger with a rectangular-shaped extension having a first end containing three circular openings and a second end defining the tip of the first bottom clamp finger;
a pneumatic cylinder having a cylinder rod with the first end of the pneumatic cylinder, having a horizontally extending cylindrical opening, removably maintained between the first and second side plates and the second end of the pneumatic cylinder is at the distal end of the cylinder rod with said second end having a cylindrical opening;
a pair of mechanical links with each said mechanical link having a first end and a second end with circular openings adjacent to each end;
a plurality of pivot pins; and
one or more impact or proximity triggers.

17. The apparatus of claim 16 wherein the top clamp finger is rotatably attached to the first side plate by means of a pivot pin.

18. The apparatus of claim 16 wherein the first end of the pneumatic cylinder is removably maintained between the first and second side plates by means of a pivot pin and the second end of the pneumatic cylinder is removably attached to the bottom clamp finger by means of a pivot pin.

19. The apparatus of claim 16 wherein the opening adjacent to the first end of each mechanical link is aligned with and rotatably attached with a pivot pin to the top clamp finger and the opening adjacent to the second end of each mechanical link is aligned with and rotatably attached with a pivot pin to the bottom clamp finger.

20. The apparatus of claim 16 wherein the pneumatic cylinder is utilized to move the clamp fingers to an open position and a closed position.
